(19) United States
(12) Patent Application Publication
(10) Pub. No.: US 2010/0325960 A1
(43) Pub. Date: Dec. 30, 2010

(54) System And Method For Closing An Access To A Vehicle

(76) Inventor: John Arthur McEwan, Alexandria, VA (US)

Correspondence Address: NIXON PEABODY, LLP, 401 9TH STREET, NW, SUITE 900, WASHINGTON, DC, 20004-2128, US

(21) Appl. No.: 12/493,748

(22) Filed: Jun. 29, 2009

(51) Int. Cl. E05F 1/00; E05F 15/20; B60J 5/10; E06B 3/00; B60Q 1/26; B60Q 1/00

(52) U.S. Cl. 49/31; 16/71; 296/193.08; 49/506; 362/488; 340/425.5

(57) ABSTRACT

A first door corresponds to a first section of a vehicle and can open/close a first access to the first section. At least one barrier corresponds to a second door of the vehicle, where the second door corresponds to a second section and the at least one barrier can open/close a second access to the second section. The first section is connected to the second section to allow air to pass therebetween. A coupling between the first door and the at least one barrier operates the at least one barrier to open the corresponding second access in response to the first door being opened and operates the at least one barrier to close the corresponding second access in response to the first door being closed. The corresponding second access allows air to exit the first section and the second section as the first door is closed.

### BACKGROUND OF THE INVENTION

1. Field of the Invention

The invention pertains to a system and method for closing an access to a vehicle and, more particularly, to a system and method that facilitates closing an access to a vehicle by minimizing resistance caused by air pressure in the interior of the vehicle.

2. Description of Related Art

Many vehicles include a rear interior section that is disposed behind a passenger seating section and that permits storage of luggage or other items. Such vehicles may have a rear door that provides direct access to the rear interior section. In some cases, a vehicle, such as a hatchback, a station wagon, a mini-van, or the like, may have an integrated cargo section that shares the same cabin space as the passenger seating section. To provide direct access to the integrated cargo section, the vehicle may include a tailgate that opens and closes a rear opening to the interior cargo section.

The tailgate is typically hinged to the vehicle at one edge so that it can pivot and open an access to the rear interior section at the opposing edge. A locking mechanism, such as a latch, may be employed at this opposing edge to ensure that the access to the rear interior section remains closed by the tailgate. In most cases, the tailgate is operated manually to open and close the access. As such, an operator must apply sufficient force to ensure that the tailgate has closed properly with the locking mechanism. However, as the tailgate pivots into a closed position, the tailgate often pushes air into the interior of the vehicle, which causes the pressure to increase within the interior of the vehicle. The increasing pressure within the interior of the vehicle provides resistance to the tailgate as it is closed and often requires the operator to apply greater force to close the tailgate completely.

To facilitate the operation of the tailgate and ensure proper closure, some vehicles may provide an electromechanical system that reduces manual effort by the operator. For example, in more recent models of the Chevrolet® Corvette®, an electric motor is employed to move the tailgate automatically into a completely closed position by acting against the pressure within the interior of the vehicle during the last few inches before complete closure. However, the use of such electromechanical systems is often accompanied by disadvantages, such as increased cost and the need for maintenance, repair, or replacement. Although the actual cost of the electromechanical system may be relatively small in some cases, the cost associated with implementing an electromechanical system for an entire line of cars may be significant. In particular, such an implementation may impact many aspects of the supply, manufacturing, and distribution chains. For example, the manufacturer must develop and design the specifications for the electromechanical system and then negotiate with one or more suppliers to manufacture the constituent parts of the electromechanical system according to the specifications. The suppliers must procure, test, and maintain inventories of materials and sub-parts to make the constituent parts. To make the constituent parts, the suppliers must implement the appropriate tooling and manufacturing processes and must train their employees accordingly. Once the constituent parts are made, the suppliers must ship the constituent parts to the manufacturer, who must test and maintain inventories of the constituent parts. The manufacturer must then assemble vehicles with the constituent parts and test the electromechanical system in the assembled vehicles. To assemble the vehicles, the manufacturer must design the assembly process to include implementation of the electromechanical system and must train the assembly workers accordingly. Once the vehicles are assembled and shipped to the sellers or dealers, the manufacturer must track the use of the electromechanical system in sold vehicles for purposes of recall, redesign, etc. The sellers must also be trained in the use of the electromechanical system. In addition, repair/maintenance of the electromechanical system may be required in the sold vehicles. The repair/maintenance also requires additional training of the appropriate personnel. Furthermore, each step in the process is likely to be accompanied by other administrative and management costs. Thus, the use of the electromechanical device is achieved only with significant effort, resource consumption, and expense.

In addition, in the case of the Chevrolet® Corvette®, the electric motor also adds undesirable weight to the vehicle. As a result, the electric motor is not employed in high-performance models, such as the Chevrolet® Corvette® Z06®, to minimize weight and maximize performance. Without an electromechanical system for the tailgate though, an operator must often slam the tailgate into a closed position. In addition to requiring more effort from the operator and possibly causing bodily injury, slamming the tailgate may result in greater wear on the seals between the tailgate and the vehicle, or on other parts, such as the tailgate hinges.

### BRIEF SUMMARY OF THE INVENTION

In view of the foregoing, embodiments according to aspects of the present invention provide a system and method for facilitating closure of a door of a vehicle. In particular, the embodiments eliminate the need for an electromechanical system to close the door against air pressure in the interior of the vehicle and ensure that the door is completely closed. Furthermore, the embodiments facilitate closure of a door that may not have a corresponding indexable window, or other operable barrier, that may be opened to relieve pressure in the interior of the vehicle as the door is closed.

For example, one embodiment includes a first door corresponding to a first section of a vehicle and at least one barrier corresponding to a second door of the vehicle. The first door is operated to open and close a first access to the first section. The second door corresponds to a second section of the vehicle and the at least one barrier is operated to open and close a second access to the second section. The first section is connected to the second section to allow air to pass therebetween. A coupling between the first door and the at least one barrier operates the at least one barrier to open the corresponding second access in response to the first door being opened and operates the at least one barrier to close the corresponding second access in response to the first door being closed. The corresponding second access allows air to exit the first section and the second section as the first door is closed.

Another embodiment includes a first door and a second door of a vehicle. The first door has no indexable window. Meanwhile the second door has an indexable window, which is operated to open and close a window opening in response to the second door being opened or closed. A coupling between the first door and the indexable window operates the indexable window to open the window opening in response to the first door being opened and operates the indexable window to close the window opening in response to the first door being closed. The window opening allows air to exit an interior of the vehicle as the first door is closed.

Yet another embodiment includes a rear door of a vehicle operable to open and close a rear access to a rear section of an interior of the vehicle. At least one window corresponding to a passenger door of the vehicle is operable to open and close a window opening in the corresponding passenger door. The passenger door is operable to open and close a front access to a front section of the interior of the vehicle. The front section and the rear section of the interior are connected. A controller is coupled to the at least one window and operates the at least one window in response to the corresponding passenger door being opened or closed. A sensor corresponding to the rear door sends a signal to the controller in response to the rear door being opened or closed. The controller is modified to operate the at least one window in response to receiving the signal from the sensor. The at least one window is opened when the rear door is opened to allow air to exit the interior of the vehicle as the rear door is closed.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1A illustrates an embodiment of a vehicle with a tailgate that opens according to aspects of the present invention.

FIG. 1B illustrates the vehicle of FIG. 1A with the tailgate in a closed position according to aspects of the present invention.

FIG. 2 illustrates a process for facilitating closure of a door of a vehicle according to aspects of the present invention.

FIG. 3 illustrates another embodiment of a vehicle with a trunk lid that opens and closes according to aspects of the present invention.

FIG. 4A illustrates a door window that experiences an increase in pressure within the vehicle interior when the tailgate is closed.

FIG. 4B illustrates another door window experiences an increase in pressure within the vehicle interior when the tailgate is closed.

FIG. 4C illustrates a door window that is similar to the door window of FIG. 4A and is operated according to aspects of the present invention as the tailgate is closed.

FIG. 4D illustrates a door window that is similar to the door window of FIG. 4B and is operated according to aspects of the present invention as the tailgate is closed.

### DETAILED DESCRIPTION

Embodiments according to aspects of the present invention provide a system and method for facilitating closure of a door of a vehicle. In particular, the embodiments eliminate the need for an electromechanical system to close the door against air pressure in the interior of the vehicle and ensure that the door is completely closed. As described previously, many disadvantages accompany the implementation of such an electromechanical system. In one aspect, eliminating the use of this hardware provides an environmentally-friendly solution that eliminates the corresponding consumption of resources. Furthermore, the embodiments facilitate closure of a door that may not have a corresponding indexable window, or other operable barrier, that may be opened to relieve pressure in the interior of the vehicle.

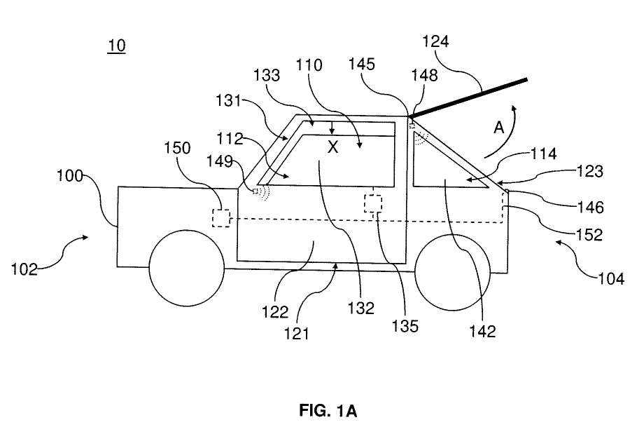

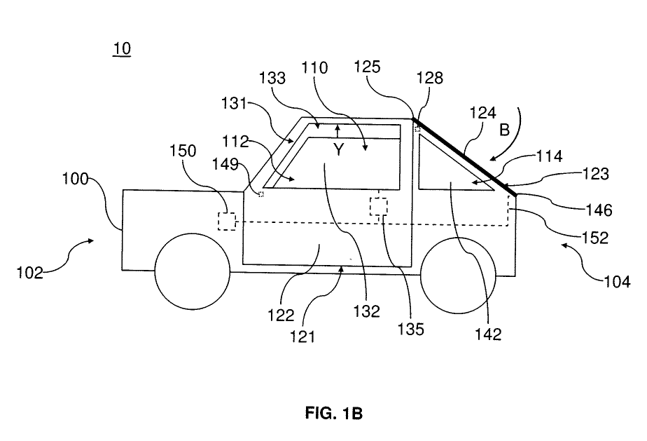

Referring to FIGS. 1A-B, the implementation of a system 10 according to aspects of the present invention is illustrated. In particular, FIGS. 1A-B illustrate a vehicle 100 with a front end 102 and a rear end 104. The vehicle 100 has an interior 110 that includes a front interior section 112 and a rear interior section 114 corresponding with the front end 102 and the rear end 104, respectively. The front interior section 112 may accommodate passenger seating, while the rear interior section 114 may accommodate cargo storage.

The vehicle 100 includes two opposing passenger doors 122 to allow passengers to enter or exit the front interior section 112 through two opposing front accesses, or openings, 121. Each of the passenger doors 122 includes a window 132 that is operable to open or close a window opening 131. In particular, the window opening 131 provides a way for air to pass into and out of the vehicle interior 110. The window 132 may be a conventional power window that moves with the operation of an electromechanical system 135 as well known in the art.

The vehicle 100 also includes a tailgate 124, or a similar rear door, that is operated to provide direct access to the rear interior section 114. Unlike the passenger doors 122, the tailgate 124 does not include a window that is operable to open or close a window opening. The tailgate 124 may pivot about a hinge 145 to open and close a rear access 123. As illustrated in FIG. 1A, the tailgate 124 is opened upwardly from the rear access 123 along a direction A to an open position. Meanwhile, as illustrated in FIG. 1 B, the tailgate 124 is moved downwardly along a direction B toward the rear access 123 into a completely closed position. A locking mechanism 146, such as a conventional tailgate latch, engages the tailgate 124 and locks the tailgate 124 in the closed position.

As the tailgate 124 pivots into the closed position, the tailgate 124 may push additional air into the vehicle interior 110. If there is no sufficient way for air to escape the vehicle interior 110, the additional air entering the rear access 123 may cause the pressure within the vehicle interior 110 to increase. This increased pressure provides resistance to the downward movement of the tailgate 124. Indeed, the amount of air pushed into the vehicle interior 110 and the corresponding interior pressure continues to increase as the tailgate 124 moves to the closed position. As such, the tailgate 124 experiences the greatest resistance just before the tailgate 124 is locked into the closed position by the locking mechanism 146. During manual operation of the tailgate 124, the resistance often requires the operator to apply a significant force to close the tailgate 124 completely. For example, the operator may have to slam the tailgate 124 into the closed position. The pressure increase and the resistance may be greater with certain vehicles, particularly high-end models, which provide very effective sealing of the vehicle interior 110 to minimize noise penetration from the exterior. In addition to requiring more effort from the operator and possibly causing bodily injury, slamming the tailgate 124 may cause greater wear on the seals between the tailgate 124 and the vehicle 100, or on other parts, such as the tailgate hinge 148. Furthermore, reducing the resistance as the tailgate 124 is closed may allow the tailgate 124 to achieve more effective contact with the seals between the tailgate 124 and the vehicle 100.

Accordingly, to facilitate closure of the tailgate 124 and minimize any harm to the operator or the vehicle 100, the system 10 automatically provides a passageway for air to escape the vehicle interior 110 and relieve at least some of the air pressure that increases when the tailgate 124 is being closed. In particular, the system 10 provides such a passageway even though a window of the tailgate 124 or other corresponding barrier may not be operable to open and to relieve the air pressure. As shown further in FIG. 1A, the system 10 automatically lowers one or more of the windows 132 of the passenger doors 122 in a direction X when the tailgate 124 has been opened along the direction A. Each window 132 may be lowered, for example, for a distance of ¾-inch to approximately 1-inch, to create a gap 133 in the corresponding window opening 131. If more than one window 132 is lowered, more than one gap 133 results. The one or more gaps 133 are maintained while the tailgate 124 remains open. As a result, the one or more gaps 133 prov ide an opening through which air from the vehicle interior 110 may escape as the tailgate 124 is closed in the direction B as shown in FIG. 1B. In other words, the one or more gaps 133 provide a way to relieve any increase in air pressure within the vehicle interior 110. According to aspects of the present invention, the system 10 operates one or more windows, i.e., windows 132 of passenger doors 122, to relieve a pressure increase that results from the operation of a door, i.e. tailgate 124, that has no corresponding operable window. Thus, resistance to the motion of the tailgate 124 along the direction B due to pressure within the vehicle interior 110 is minimized. The tailgate 124 may be closed with less force than would otherwise be required without the one or more gaps 133. The number of windows lowered and the size of the gaps 133 depend on the amount of pressure increase typically expected while the tailgate is being closed. It may be preferable, in some cases, to lower all windows 132 completely to provide the greatest amount of area for the one or more gaps 133.

As FIG. 1B further illustrates, once the tailgate 124 is closed, the one or more gaps 133 in the window openings 131 are no longer necessary to relieve pressure. Therefore, the system 10 may automatically raise the corresponding open windows 132 in the direction Y.

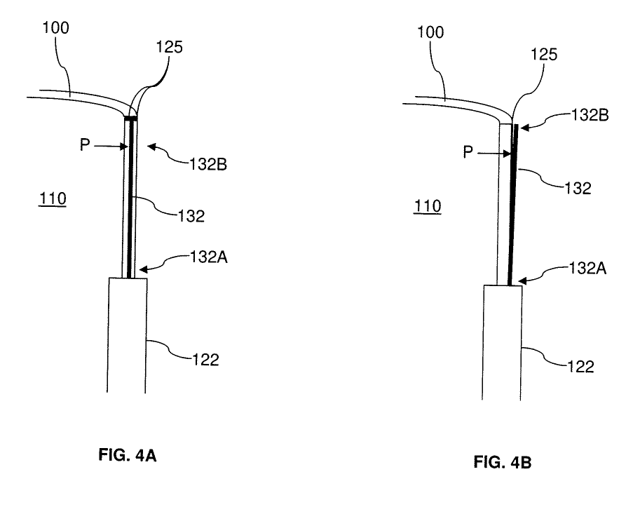

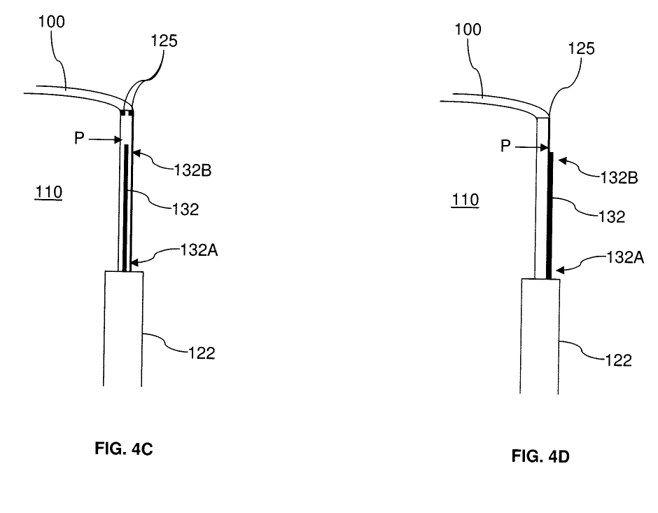

In addition to facilitating closure of the tailgate 124, the system 10 may also minimize the effects of the pressure increase on other parts of the vehicle 100. For example, the system 10 may minimize any wear or damage on the windows 132, the passenger doors 122, and/or the seals between the windows 132 and the passenger doors 122. Because the system 10 operates the windows 132 to relieve a pressure increase that results from the tailgate 124, the windows 132, which are seated with respect to the doors 122, do not experience the effect of increased pressure within the vehicle interior 110. For example, as shown in FIG. 4A, if the windows 132 remain closed as the tailgate 124 is closed, the increased pressure P within the vehicle interior 110 may act against the windows 132 and push the windows 132 outwardly. The pressure P may cause fluctuations in the contact between the upper portion 132B of the window 132 and the seals 125 around the upper portion 132B, which may result in greater wear on the seals 125. As FIG. 4B illustrates, the pressure increase may be a particular problem where the windows 132 are exterior to a seal 125 on the door 122, and the window 132 is anchored by the door at a bottom portion 132A to hold the upper portion 132B against the seal 125. FIG. 4B shows that the pressure P may produce a torque about the bottom portion 132A, which may cause wear or damage in the area where the door 122 supports the window 132. In addition, the pressure P may prevent the upper portion 132B from achieving the desired contact with the seal 125. In general, poor sealing at the seal 125 and/or damage at the door 122, window 132, and/or seals 125 may harm the ability of the vehicle 100 to block exterior noise and elements, such as water, from entering the vehicle interior 110. Because any window in the tailgate 124 is typically sealed and cannot be opened, it may not be readily apparent how the operation of the tailgate 124 may impact how the vehicle 100 is sealed from exterior noise and elements at the windows 132, where sealing may be adversely impacted by rapid changes in pressure within the vehicle interior 110.

In contrast to the examples of FIGS. 4A and 4B, FIGS. 4C and 4D, respectively, show that when the window 132 has been lowered according to aspects of the present invention, the pressure P may apply less force against the upper portion 132B and less torque is applied about the bottom portion 132A. Advantageously, the seals 125 in FIGS. 4C and 4D may suffer from less wear and/or damage than the seals 125 in the examples of FIGS. 4A and 4B, respectively.

Referring again to FIGS. 1A-B, the system 10 may employ a sensing system 152 which sends one or more signals to a controller 150 to indicate when one or more windows 132 should be lowered or raised in response to the opening or closing of the tailgate 124, respectively. In particular, the controller 150 may include a processor that receives and processes the signals. If the processor determines that the tailgate 124 has been opened, the controller 150 may send another signal to one or more electromechanical systems 135 to lower the corresponding windows 132 to create one or more gaps 133 of a pre-determined distance. On the other hand, if the processor determines that the tailgate 124 has been closed, the controller 150 may send yet another signal to the one or more electromechanical systems 135 to raise the corresponding windows 132. In some embodiments, the controller 150 may be a conventional automobile computer that controls various functions for the vehicle 100 as well known in the art. In general, the controller 150 may operate according to aspects of the present invention by executing one or more programmed instructions that are stored on a computer readable medium.

As shown in FIGS. 1A-B, the locking mechanism 146 may be a part of the sensing system 152. For example, when the tailgate 124 is engaged with the locking mechanism 146, a circuit may be closed to transmit an electrical signal to the controller 150. Conversely, when the tailgate 124 is disengaged from the locking mechanism 146, the circuit may be opened and the interruption in the electrical signal indicates that the tailgate 124 is no longer closed. In other embodiments, the sensing system 152 may be configured so that the circuit is closed when the tailgate 124 is opened and closed when the tailgate 124 is closed. In further embodiments, the sensing system 152 may employ a first circuit that is opened or closed when the tailgate 124 is opened and a second circuit that is opened or closed when the tailgate 124 is closed. In general, the sensing system 152 may employ any number and any configuration of circuits to send one or more signals to the controller 150 to communicate the state of the tailgate 124. Moreover, the sensing system 152 may employ any configuration and type of contact sensors, displacement sensors, motion sensors, or the like, to determine this state.

Indeed, other sensing systems associated with the tailgate 124 may already be implemented within the vehicle 100 to provide other functionality. For example, as shown in FIG. 1A, the vehicle 100 may provide a conventional cargo light 148 in the rear interior section 114 that turns on when the tailgate 124 is opened. As well known in the art, the cargo light 148 provides automated illumination for the rear interior section 114 when the tailgate 124 is opened. Such illumination is typically required when an individual opens the tailgate 124 and accesses the rear interior section 114. In another example, the vehicle 100 may provide a conventional warning light 149 on the vehicle dashboard as also well known in the art to alert the operator when the tailgate 124 has been opened and is not securely and safely closed.

Therefore, in some embodiments, the sensing system 152 may be integrated with other sensing systems that provide other functionality associated with the tailgate 124. In other words, an existing sensing system associated, for example, with the cargo light 148 or the warning light 149 may also be employed to determine when one or more windows 132 should be opened or closed according to aspects of the present invention. In some vehicles, implementation of the system 10 is further facilitated by the fact that these other sensing systems may already be coupled to a controller that also controls the electromechanical systems 135 that raise and lower the windows 132. Indeed, in some embodiments, the vehicle 100 that already includes a suitable sensing system coupled to a suitable controller may be efficiently retrofitted, e.g., “after market,” to include the system 10. In such embodiments, retrofitting the vehicle 100 may only require the modification of the controller software to instruct the controller 150 to lower or raise one or more windows 132 in response to the signals from the pre-existing sensing system. As a result, the need to add additional hardware to the vehicle 100 may be minimized or eliminated altogether. Moreover, additional functionality may be employed on high performance vehicles, such as Chevrolet® Corvette® Z06®, without adding undesired weight.

Additionally, the vehicle 100 may already provide functionality that causes an electromechanical system 135 to lower and raise a window 132 in response to the state of the passenger door 122 in which the particular window 132 is disposed. In other words, the door 122 may have an indexed window 132, which is lowered to form a gap 133 when the door is opened and then raised to close the gap 133 after the door 122 is closed. The controller 150 may process a signal indicating the state of the door 122 and actuate the operation of the corresponding electromechanical system 135. Lowering the window 132 in response to the door 122 in this manner facilitates closure of the door 122. Air is allowed to escape through the corresponding gap 133, relieving any increase in air pressure within the vehicle interior 110 which would otherwise provide resistance as the door 122 is closed. Accordingly, retrofitting the vehicle 100 to include the system 10 may be facilitated by employing pre-existing functionality that lowers the windows 132 in response to operation of the doors 122. Although the initial design does not lower windows in response to the tailgate 124, the system 10 may modify operation of the controller 150 to respond more broadly to signals indicating the state of the tailgate 124 in addition to the state of the doors 122. In other words, the system 10 causes the controller 150 to operate one or more windows 124 of passenger doors 122 to relieve a pressure increase that results from the operation of the tailgate 124, which has no corresponding indexable window. For example, the pre-existing programmed instructions for the controller 150 may include code that operates a particular electromechanical system 135 to lower or raise the corresponding window 132 according to a programmed condition, e.g., “if” statement, based on signals from the corresponding door 122. The retrofitted vehicle 100 may use the pre-existing code to operate the electromechanical systems 135, but the programmed condition is modified to include signals from the tailgate 124. In some cases, such a modification may involve minimal changes to the code with the addition of an OR gate to include signals from the tailgate 124. Although the vehicle 100 may be originally designed to lower only a single window 132 in response to the opening of a corresponding door 122, the system 10 may cause all windows 132 to open in response to the opening of the tailgate 124. As described previously, it may be preferable to lower all windows 132 completely to provide the greatest amount of area for the gaps 133.

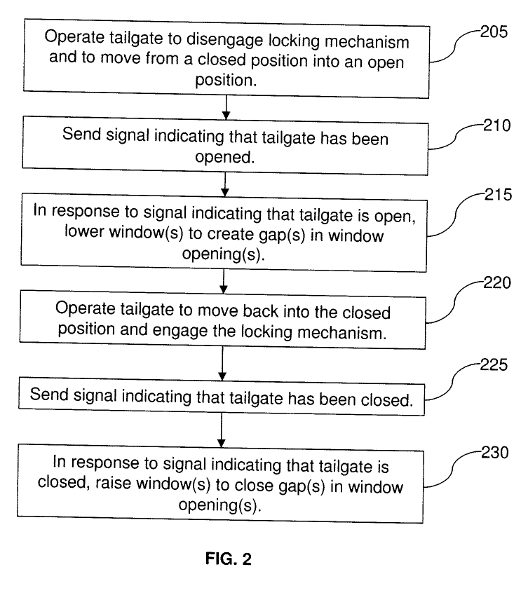

Accordingly, the operation of the system 10 is summarized in FIG. 2. In step 205, an operator disengages the tailgate 124 from the locking mechanism 146 and opens the tailgate 124. In response to step 205, the sensing system 152 sends a corresponding signal in step 210. Upon receiving the signal from the sensing system 152 in step 210, the controller 150 automatically lowers one or more windows 132 in step 215 to create one or more gaps 133. In step 220, the operator closes the tailgate 124 which engages the locking mechanism 146. During the operation of the tailgate 124 in step 220, the one or more gaps 133 enable air to escape the vehicle interior 110 to minimize a pressure increase in the vehicle interior 110 that may resist proper closing of the tailgate 124. In response to the complete closing of the tailgate 124 in step 220, the sensing system 152 sends a corresponding signal in step 225. Upon receiving the signal from the sensing system 152 in step 210, the controller 150 automatically raises the one or more windows 132 in step 230 to close the one or more gaps 133.

For example, in some embodiments, the controller 150 may determine an initial state of the windows 132 before the tailgate is opened 124, and rather than closing the one or more gaps 133 completely as shown in step 230, the controller 150 may return the windows 132 to their initial state in response to the complete closing of the tailgate 124. For example, the windows 132 may already be open when the tailgate 124 is opened. The controller 150 may determine how much farther the windows 132 need to be lowered to create the desired gaps 133 and then actuates the electromechanical systems 135 to lower the appropriate windows 132 only to reach the required distance. Once the tailgate 124 is closed, the controller 150 may return the windows 132 to their previous open positions. However, if the controller 150 determines that the desired gaps 133 already exist and that the need to lower the windows 132 in step 215 has been obviated, the controller may not actuate the electromechanical systems 135 at all.

Additionally, the controller 150 may determine a state of the doors 122 or another operable barrier to the vehicle interior 110, such as a sunroof or convertible top, and may bypass operation of the windows 132 if any of the doors 122 or other operable barriers are open and already provide a sufficient way to relieve any increase in air pressure within the vehicle interior 110. Indeed, if the windows 132 are lowered in response to the opening of the doors 122 as described above, the windows 132 may already be in a lowered position, so further operation of the windows 132 is not required when the tailgate 124 is opened. Of course, if the controller 150 determines that the doors 122 and/or other opening are closed and the tailgate 124 remains open, the controller 150 may then operate the windows 132 to form the necessary gaps 133. In general, the operation of the windows 132 in response to the state of the tailgate 124 may depend on the state of any combination of the doors 122, windows 132, and/or other operable barriers that provide openings for the passage of air out of the vehicle interior 110. To reduce wear and power consumption, it may be preferable, in some cases, not to open any of the windows 132 if any other openings are already available.

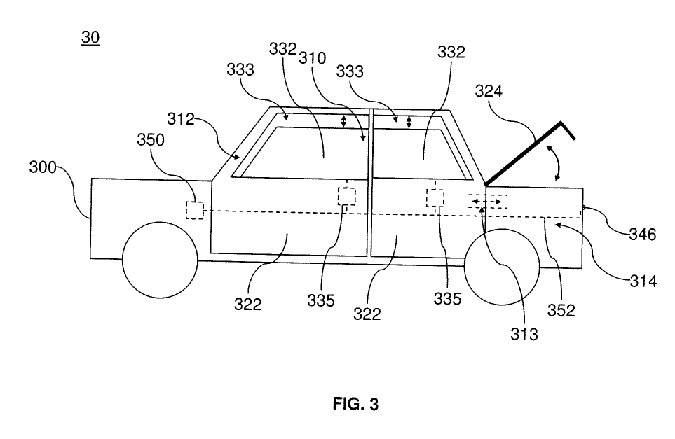

Although FIGS. 1A-B show a vehicle 100 having a hatchback configuration with the two passenger doors 122 and the top-hinged tailgate 124, aspects of the present invention may be employed with other vehicle configurations. For example, FIG. 3 illustrates an alternative system 30 that is employed on a vehicle 300 that has a conventional sedan configuration with four passenger doors 322 and a trunk 314 with a trunk lid 324. Similar to the system 10 described previously, the system 30 lowers and raises one or more windows 332 in response to the opening and closing of a trunk lid 324, respectively. As also shown in FIG. 3, the vehicle 300 may include a controller 350 that receives and processes signals from a sensing system 352 to determine the state of the trunk lid 324 and that actuates electromechanical system 335 to open and close gaps 333 with one or more of the windows 332. Like the system 10 above, the sensing system 352 may employ a locking mechanism 346 that locks the trunk lid 324 into the closed position to determine the state of the trunk lid 324.

As shown in FIGS. 1A-B, the rear interior section 114 clearly shares the same pressure envelope as the front interior section 112. In other words, the front interior section 112 and the rear interior section 114 generally make up a single vehicle interior 110. As such, air can move freely from the rear interior section 114 to the front interior section, and the pressure relief provided by the one or more gaps 133 in the front interior section 112 also provides relief for the rear interior section 114. Indeed, if the front interior section 112 were not connected to the rear interior section 114 to allow air to pass therebetween, the increase in pressure in the rear interior section 114 caused by the closing of the tailgate 124 could not be reduced by the one or more gaps 133 formed by the windows 132.

Similarly, the trunk 314 of the vehicle 300 of FIG. 3 must also be connected in some way to the front interior section 312. Accordingly, FIG. 3 illustrates a passageway 313 for air to flow sufficiently between the trunk 314 and the front interior section 312. Although many conventional sedans may provide some separation between the passenger seating section, i.e., the front interior section 312, from the trunk 314, the separation may not be a complete barrier that prevents air from flowing sufficiently between the trunk 314 and the front interior section 312. However, if there is insufficient air flow between the front interior section 312 and the trunk 314, a specific passageway 313 may need to be formed. As such, the front interior section 312 and the trunk 314 form a common vehicle interior 310 and share the same pressure envelope.

As discussed previously, some vehicles may provide electromechanical systems that reduces or eliminates manual effort by the operator to ensure proper closure. Although aspects of the present invention may eliminate the need for such electromechanical systems and to facilitate the manual operation of a door, such as a tailgate or trunk lid, some embodiments may employ the systems describe herein in combination with an automated closure system for the door. By reducing the pressure in the vehicle interior, the automated closure system is required to apply less force against the pressure in the vehicle interior to close the door completely. As a result, a smaller electromechanical system may be employed. Moreover, the automated closure system may experience less wear, thereby minimizing burn out of the electromechanical system and the need for repairs.

As described previously, embodiments according to aspects of the present invention may operate windows in passenger doors to create openings that allow air to escape from the vehicle interior and reduce pressure in the vehicle interior. The passenger door windows are employed, because the door being closed does not have an indexable window, or other operable barrier, to provide a opening as the door is closed. In other words, the door cannot lower its own indexable window, so embodiments provide an approach that allows the door to lower windows corresponding to other doors. In particular, the use of the windows in these embodiments may be advantageous due to the mechanisms that may already be in place to lower or raise the windows automatically. Indeed, the passenger door windows may be indexed to open or close a window opening in response to the opening and closing of the passenger doors.

However, embodiments are not limited to the use of passenger door windows to create openings to reduce pressure. In some embodiments, another type of window, such as the window 142 shown in FIGS. 1A-B, corresponding to another aspect of the vehicle may be lowered, pivoted, or otherwise opened to reduce pressure in the vehicle interior. Indeed, embodiments are not limited to just the use of windows, and embodiments may operate other types of barriers that provide access between the vehicle interior and areas outside the vehicle. For example, some embodiments may open one or more of the passenger doors to allow air inside the vehicle interior to escape. Meanwhile, other embodiments may open one or more vents corresponding to other parts of the vehicle to allow air inside the vehicle interior to escape.

In addition, when embodiments are described with reference to passenger doors, it is understood that the passenger doors provide access to any of the vehicle passengers and, as such, may include the driver door and/or non-driver doors. Moreover, embodiments according to aspects of the present invention are not limited to doors that are intended for passenger access.

While various embodiments in accordance with the present invention have been shown and described, it is understood that the invention is not limited thereto. The present invention may be changed, modified and further applied by those skilled in the art. Therefore, this invention is not limited to the detail shown and described previously, but also includes all such changes and modifications.

What is claimed is:

1. A system for facilitating closure of a door of a vehicle, comprising:
a first door corresponding to a first section of a vehicle, the first door operable to open and close a first access to the first section;
at least one barrier corresponding to a second door of the vehicle, the second door corresponding to a second section of the vehicle, the at least one barrier being operable to open and close a second access to the second section, the first section being connected to the second section to allow air to pass therebetween; and
a coupling between the first door and the at least one barrier, the coupling operating the at least one barrier to open the corresponding second access in response to the first door being opened and operating the at least one barrier to close the corresponding second access in response to the first door being closed, the corresponding second access allowing air to exit the first section and the second section as the first door is closed.

2. The system according to claim 1, wherein the at least one barrier comprises a window and the second access is a window opening in the second door.

3. The system according to claim 2, wherein the window is further operable to open and close the window opening according to operation of the second door.

4. The system according to claim 2, wherein when the window closes the window opening, an interior pressure against the window from the second section is substantially at equilibrium with an exterior pressure against the window from outside the second section, the window providing a predetermined seal against the second door.

5. The system according to claim 1, wherein the coupling comprises:
a sensor that provides a first door signal in response to the first door being opened or closed; and
an electromechanical system that operates the at least one barrier in response to the first door signal.

6. The system according to claim 5, wherein the coupling further comprises a computer that receives the first door signal from the sensor and operates the electromechanical system according to instructions provided on a computer-readable medium.

7. The system according to claim 5, wherein the electromechanical system receives a second door signal when the second door corresponding to the at least one barrier is opened or closed, and the electromechanical system operates the at least one barrier in response to the second door signal.

8. The system according to claim 5, wherein the sensor is included in a lighting circuit that is closed or opened when the first door is opened, the lighting circuit providing interior lighting for the vehicle.

9. The system according to claim 5, wherein the sensor is included in an alert circuit that is closed or opened when the first door is opened, the alert circuit providing an alert when the first door is opened.

10. The system according to claim 1, wherein the first section is a rear interior section and the second section is a front interior section.

11. The system according to claim 10, wherein the vehicle is a hatchback, the first access providing a hatchback opening and the first door providing a tailgate.

12. The system according to claim 10, wherein the first section is a trunk, the first access providing a trunk opening and the first door providing a trunk lid.

13. A method for facilitating closure of a door of a vehicle, the vehicle comprising a first door corresponding to a first section of a vehicle, the first door operable to open and close a first access to the first section; at least one barrier corresponding to a second door of the vehicle, the second door corresponding to a second section of the vehicle, the at least one barrier being operable to open and close a second access to the second section, the first section being connected to the second section to allow air to pass therebetween, the method comprising:
operating the at least one barrier to open the second access in response to the first door being opened, the second access allowing air to exit the first section and the second section as the first door is closed; and
operating the at least one barrier to close the second access after the first door is closed.

14. The method according to claim 13, wherein the at least one barrier comprises a window and the second access is a window opening in the second door.

15. The method according to claim 14, wherein the window is further operable to open and close the window opening according to operation of the second door.

16. The method according to claim 14, wherein when the window closes the window opening, an interior pressure against the window from the second section is substantially at equilibrium with an exterior pressure against the window from outside the second section, the window providing a predetermined seal against the second door.

17. The method according to claim 14, wherein operating the at least one barrier to open the second access comprises:
receiving, from a sensor, a first door signal in response to the first door being opened or closed; and
operating, with an electromechanical system, the at least one barrier in response to the first door signal.

18. The method according to claim 17, wherein receiving a first door signal comprises receiving the first door signal at a computer, and operating the at least one barrier comprises operating, by the computer, the electromechanical system according to instructions provided on a computer-readable medium.

19. The method according to claim 18, wherein the electromechanical system receives a second door signal when the second door corresponding to the at least one barrier is opened and operates the at least one barrier in response to the second door signal.

20. The method according to claim 19, further comprising modifying the instructions on the computer-readable medium to instruct the computer to operate the electromechanical system in response to the first door signal in addition to the second door signal.

21. The method according to claim 17, wherein the sensor is included in a lighting circuit that is closed or opened when the first door is opened, the lighting circuit providing interior lighting for the vehicle.

22. The method according to claim 17, wherein the sensor is included in an alert circuit that is closed or opened when the first door is opened, the alert circuit providing an alert when the first door is opened.

23. A system for facilitating closure of a door of a vehicle, comprising:
a first door of a vehicle, the first door having no indexable window;
a second door of the vehicle, the second door having an indexable window, the indexable window being operable to open and close a window opening in response to the second door being opened or closed; and
a coupling between the first door and the indexable window, the coupling operating the indexable window to open the window opening in response to the first door being opened and operating the indexable window to close the window opening in response to the first door being closed, the window opening allowing air to exit an interior of the vehicle as the first door is closed.

24. The system according to claim 23, wherein the coupling comprises:
a sensor that provides a signal in response to the first door being opened or closed; and
an electromechanical system that operates the indexable window in response to the signal.

25. The system according to claim 24, wherein the electromechanical system receives a second door signal when the second door corresponding to the indexable window is opened or closed, and the electromechanical system operates the indexable window in response to the second door signal.

26. The system according to claim 24, wherein the sensor is included in a lighting circuit that is closed or opened when the first door is opened, the lighting circuit providing interior lighting for the vehicle.

27. The system according to claim 24, wherein the sensor is included in an alert circuit that is closed or opened when the first door is opened, the alert circuit providing an alert when the first door is opened.

28. A system for facilitating closure of a door of a vehicle, comprising:
a rear door of a vehicle, the rear door being operable to open and close a rear access to a rear section of an interior of the vehicle;
at least one window corresponding to a passenger door of the vehicle, the at least one window being operable to open and close a window opening in the corresponding passenger door, the passenger door being operable to open and close a front access to a front section of the interior of the vehicle, the front section and the rear section of the interior being connected;
a controller coupled to the at least one window, the controller operating the at least one window in response to the corresponding passenger door being opened or closed;
a sensor corresponding to the rear door, the sensor sending a signal to the controller in response to the rear door being opened or closed,
wherein the controller is modified to operate the at least one window in response to receiving the signal from the sensor, the at least one window being opened when the rear door is opened to allow air to exit the interior of the vehicle as the rear door is closed.

29. A method for facilitating closure of a door vehicle, the vehicle comprising a rear door, the rear door being operable to open and close a rear access to a rear section of an interior of the vehicle; at least one window corresponding to a passenger door of the vehicle, the at least one window being operable to open and close a window opening in the corresponding passenger door, the passenger door being operable to open and close a front access to a front section of the interior of the vehicle, the front section and the rear section of the interior being connected; a controller coupled to the at least one window, the controller operating the at least one window in response to the corresponding passenger door being opened or closed; and a sensor corresponding to the rear door, the sensor sending a signal to the controller in response to the rear door being opened or closed, the method comprising:
modifying the controller to operate the at least one window in response to receiving the signal from the sensor, the at least one window being opened when the rear door is opened to allow air to exit the interior of the vehicle as the rear door is closed.
